(19) United States
(12) Patent Application Publication
(10) Pub. No.: US 2019/0087585 A1
(43) Pub. Date: Mar. 21, 2019

(54) IMAGE PROCESSING APPARATUS AND NON-TRANSITORY COMPUTER READABLE MEDIUM STORING PROGRAM

(71) Applicant: FUJI XEROX CO., LTD., Tokyo (JP)

(72) Inventor: Yoshikazu UGAI, Kanagawa (JP)

(73) Assignee: FUJI XEROX CO., LTD., Tokyo (JP)

(21) Appl. No.: 16/131,062

(22) Filed: Sep. 14, 2018

(30) Foreign Application Priority Data
Sep. 21, 2017 (JP) 2017-181072

(51) Int. Cl. G06F 21/57; H04L 29/06

(52) U.S. Cl. CPC G06F 21/577; H04L 63/12; H04L 63/1433

(57) ABSTRACT

An image processing apparatus includes: an information storage unit that stores plural application programs; an information acquisition section that acquires information about an application program having vulnerability; a specification section that specifies an application program, which corresponds to the application program having the vulnerability and has a usage result, among the application programs stored in the information storage unit; and an update section that updates the application program specified by the specification section.

### CROSS-REFERENCE TO RELATED APPLICATIONS

This application is based on and claims priority under 35 USC 119 from Japanese Patent Application No. 2017-181072 filed Sep. 21, 2017.

### BACKGROUND

### Technical Field

The present invention relates to an image processing apparatus and a non-transitory computer readable medium storing a program.

### SUMMARY

According to an aspect of the invention, there is provided an image processing apparatus including: an information storage unit that stores plural application programs; an information acquisition section that acquires information about an application program having vulnerability; a specification section that specifies an application program, which corresponds to the application program having the vulnerability and has a usage result, among the application programs stored in the information storage unit; and an update section that updates the application program specified by the specification section.

### BRIEF DESCRIPTION OF THE DRAWINGS

Exemplary embodiment(s) of the present invention will be described in detail based on the following figures, wherein:

FIG. 1 is a diagram illustrating an example of an information processing system;

FIG. 2 is a diagram illustrating a hardware configuration of a first image forming apparatus;

FIG. 3 is a diagram illustrating functional units included in the first image forming apparatus;

FIGS. 4A to 4D are diagrams illustrating information stored in an information storage unit;

FIG. 5 is a flowchart illustrating a flow of a series of processes which are performed in the information processing system; and

FIG. 6 is a flowchart illustrating a flow of a series of processes which are performed in the information processing system.

### DETAILED DESCRIPTION

Hereinafter, an exemplary embodiment of the present invention will be described in detail with reference to the accompanying drawings.

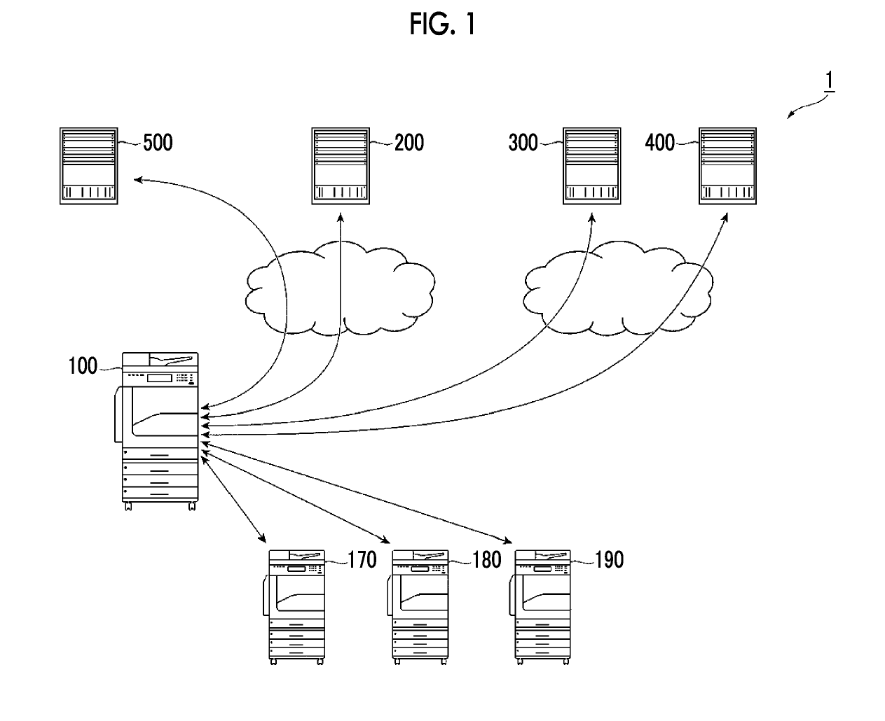

FIG. 1 is a diagram illustrating an example of an information processing system 1 according to the exemplary embodiment.

The information processing system 1 is provided with a first image forming apparatus 100 which forms an image on paper which is an example of a record material.

The first image forming apparatus 100 has a FAX transmission function, a copying function, and a scan function used to read a document, in addition to an image forming function.

Furthermore, the information processing system 1 is provided with a vulnerability information storage server 200 which stores information about an application program having vulnerability.

Furthermore, the information processing system 1 is provided with a first program storage server 300 which stores an application program A, and a second program storage server 400 which stores an application program B.

Furthermore, the information processing system 1 is provided with a test data storage server 500 which stores test data.

Here, in the exemplary embodiment, the first image forming apparatus 100 and the four servers (the vulnerability information storage server 200, the first program storage server 300, the second program storage server 400, and the test data storage server 500) are connected to each other via an information communication line such as the Internet.

Furthermore, the information processing system 1 is provided with a second image forming apparatus 170, a third image forming apparatus 180, and a fourth image forming apparatus 190. The second image forming apparatus 170, the third image forming apparatus 180, and the fourth image forming apparatus 190 are connected to the first image forming apparatus 100 via a communication line such as a Local Area Network (LAN).

Meanwhile, the second image forming apparatus 170, the third image forming apparatus 180, and the fourth image forming apparatus 190 have the same functions as the first image forming apparatus 100, that is, have an image forming function, a FAX transmission function, a copying function, a scan function, and the like.

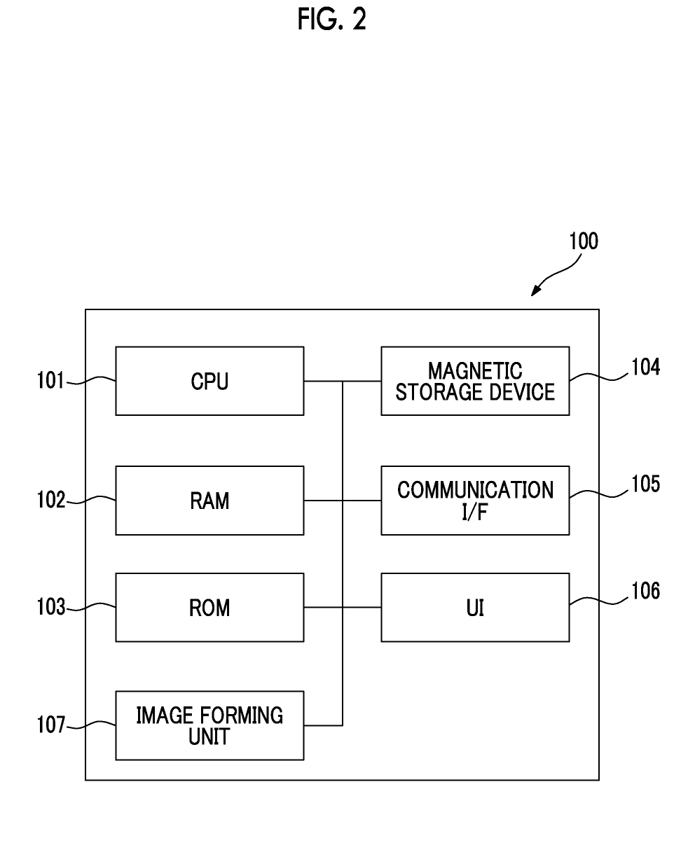

FIG. 2 is a diagram illustrating a hardware configuration of the first image forming apparatus 100. Meanwhile, the second image forming apparatus 170, the third image forming apparatus 180, and the fourth image forming apparatus 190 are also configured in the same manner as the first image forming apparatus 100.

As illustrated in FIG. 2, the first image forming apparatus 100 includes a Central Processing Unit (CPU) 101, a Random Access Memory (RAM) 102, a Read Only Memory (ROM) 103, and a magnetic storage device 104. Furthermore, the image forming apparatus 100 includes a communication interface (communication I/F) 105 used to perform communication with the outside.

Furthermore, the image forming apparatus 100 includes a User Interface (UI) 106 and an image forming unit 107.

The UI 106 is configured to include a display device. The display device is configured with, for example, a display of a touch panel method. The UI 106 receives information to be displayed, and displays (notifies) the information with respect to a user. In addition, the UI 106 receives an operation from the user.

The image forming unit 107 forms an image on paper, which is an example of a record material, using an electronic picture method, an ink jet head method, or the like. In other words, the image forming unit 107 performs an image forming processing which is a processing performed on an image.

Here, the first image forming apparatus 100 according to the exemplary embodiment has a function of performing a processing relevant to the image as described above, and is understood as an image processing apparatus.

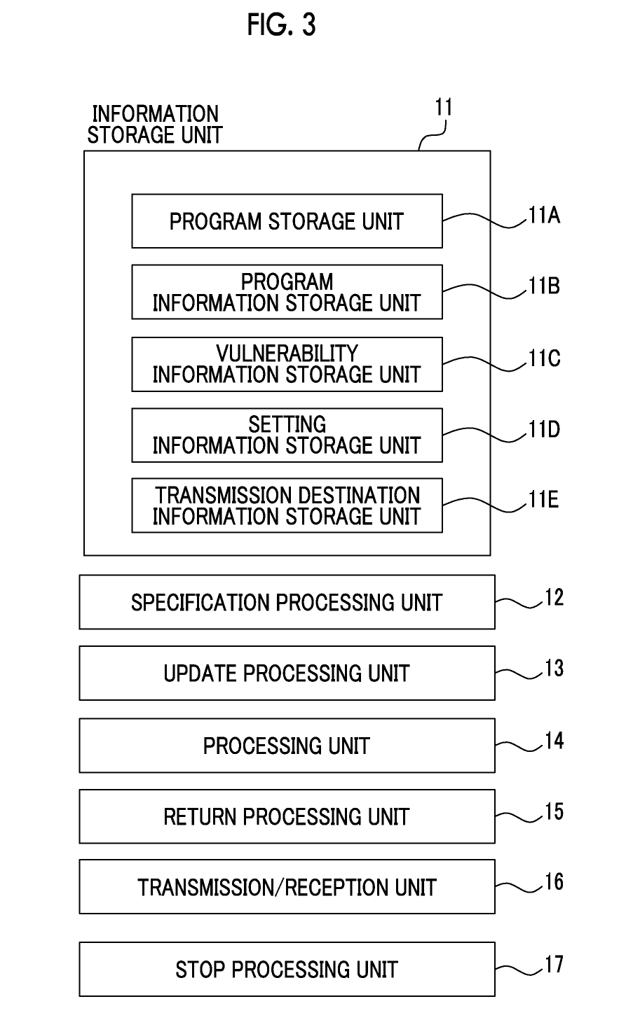

The ROM 103 or the magnetic storage device 104 stores a program which is executed by the CPU 101. The CPU 101 reads a program which is stored in the ROM 103 or the magnetic storage device 104, and executes the program while using the RAM 102 as a work area. Therefore, various functional units illustrated in FIG. 3 are realized.

The program, which is executed by the CPU 101, may be provided to the first image forming apparatus 100 in a state of being stored in a computer-readable recording medium such as a magnetic recording medium (a magnetic tape, a magnetic disk, or the like), an optical recording medium (an optical disk or the like), a magneto-optical recording medium, or a semiconductor memory. In addition, the program, which is executed by the CPU 101, may be downloaded to the first image forming apparatus 100 using a communication section such as the Internet.

FIG. 3 is a diagram illustrating the functional units included in the first image forming apparatus 100. Meanwhile, FIG. 3 displays only functional units relevant to an update processing performed on the application programs.

The first image forming apparatus 100 includes an information storage unit 11, a specification processing unit 12, an update processing unit 13, a processing unit 14, a return processing unit 15, a transmission/reception unit 16, and a stop processing unit 17.

The information storage unit 11 is realized by, for example, the magnetic storage device 104.

The information storage unit 11 is provided with a program storage unit 11A, a program information storage unit 11B, a vulnerability information storage unit 11C, a setting information storage unit 11D, and a transmission destination information storage unit 11E.

The program storage unit 11A stores an application program which is installed in the first image forming apparatus 100. In the exemplary embodiment, the program storage unit 11A stores two application programs, that is, the application program A and the application program B.

The program information storage unit 11B stores information about the application programs (the application programs stored in the program storage unit 11A) installed in the first image forming apparatus 100.

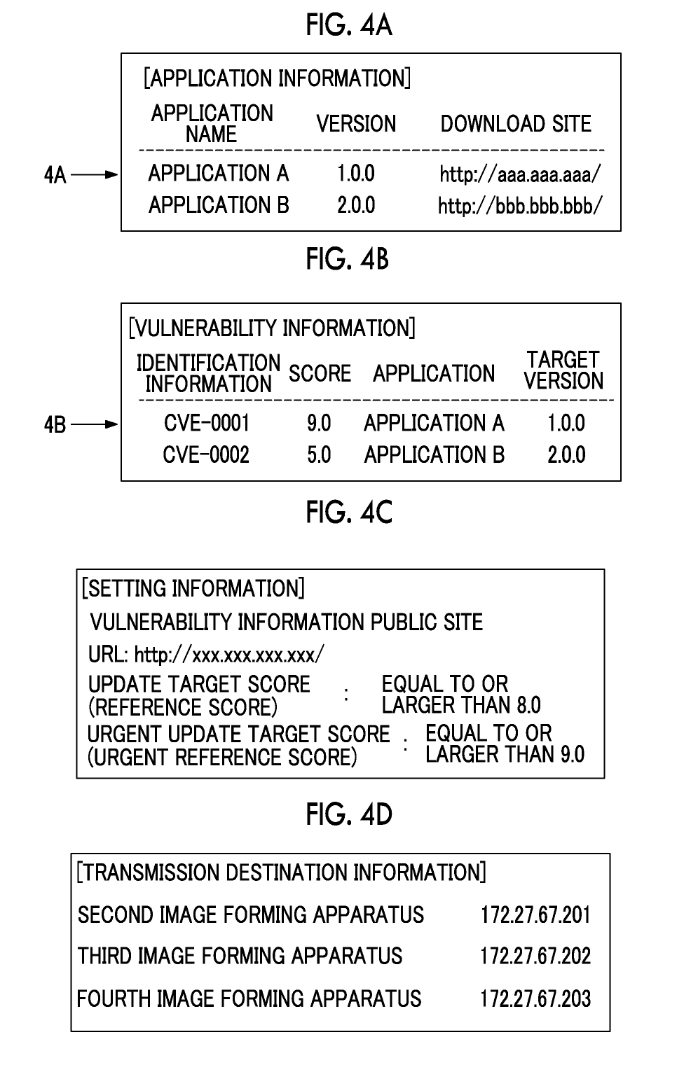

Specifically, the program information storage unit 11B stores a name of each of the application programs, version information of each of the application programs, and acquisition destination information indicative of an acquisition destination of each of the application programs, as illustrated in FIG. 4A (drawing illustrating information stored in the information storage unit 11). More specifically, in the example, a URL of a download site of each of the application programs is stored as the acquisition destination information.

Here, in the exemplary embodiment, a version of the application program A is 1.0.0, as illustrated in FIG. 4A. In addition, a version of the application program B is 2.0.0.

Furthermore, in the exemplary embodiment, an acquisition destination (download site) of the application program A is (a site managed by) the first program storage server 300. In addition, an acquisition destination (download site) of the application program B is (a site managed by) the second program storage server 400.

The vulnerability information storage unit 11C (refer to FIG. 3) stores information relevant to vulnerability (hereinafter, “vulnerability information”) acquired from the vulnerability information storage server 200. FIG. 4B illustrates the vulnerability information stored in the vulnerability information storage unit 11C.

In the exemplary embodiment, as the vulnerability information, identification information used to identify each vulnerability information, a score as an example of risk degree information indicative of a risk degree of the vulnerability, a name of an application program having the vulnerability, and a target version of the application program having the vulnerability are stored in a state of being associated with each other, as illustrated in FIG. 4B.

The setting information storage unit 11D (refer to FIG. 3) stores setting information which is set by a setting person.

The setting information storage unit 11D stores the acquisition destination information indicative of an acquisition destination of the vulnerability information, as illustrated in FIG. 4C. In the exemplary embodiment, as an example of the acquisition destination information, an URL of the vulnerability information storage server 200 (an URL of an information public site which is managed by the vulnerability information storage server 200) is stored.

Furthermore, the setting information storage unit 11D stores a reference score which is an example of a determination reference used to determine whether or not to update (update process) the application program, as illustrated in FIG. 4C.

Furthermore, the setting information storage unit 11D stores an urgent reference score which is an example of an urgent determination reference used to determine whether or not to perform urgent update (the update process).

Meanwhile, the reference score or the urgent reference score may be changed by a change processing performed by the setting person.

The transmission destination information storage unit 11E (refer to FIG. 3) stores transmission destination information indicative of a transmission destination in a case where information is transmitted to each of the second image forming apparatus 170, the third image forming apparatus 180, and the fourth image forming apparatus 190, as illustrated in FIG. 4D. Specifically, in the example, an IP address is stored as an example of the transmission destination information.

In the exemplary embodiment, as will be described later, there is a case where the information is transmitted to each of the second to fourth image forming apparatuses 170 to 190 from the first image forming apparatus 100. In this case, the transmission destination information is used, and the information is transmitted to the second to fourth image forming apparatuses 170 to 190.

Another functional unit included in the first image forming apparatus 100 will be described with reference to FIG. 3.

The specification processing unit 12 as an example of a specification section specifies an application program, which satisfies a specific condition, among the application programs stored in the program storage unit 11A.

Specifically, the specification processing unit 12 specifies an application program, which corresponds to the application program having the vulnerability, and has a usage result and a higher risk degree of the vulnerability than a predetermined risk degree, among the application programs stored in the program storage unit 11A.

The update processing unit 13 as an example of an update section performs the update processing on the application program which is specified by the specification processing unit 12.

Specifically, the update processing unit 13 performs version-up on the application program, which is specified by the specification processing unit 12 as the application program that satisfies the specific condition relevant to the vulnerability, among the application programs stored in the program storage unit 11A.

The processing unit 14 as an example of a processing section performs a processing with respect to the test data using an updated application program which is an application program on which the update processing is performed by the update processing unit 13. Therefore, it is possible to determine whether or not the updated application program is an application program which satisfies a predetermined condition (an application program capable of performing an intended process).

In a case where a result of the processing with respect to the test data does not satisfy the predetermined condition, the return processing unit 15 as an example of the return section returns the updated application program to a state before the update is performed.

Here, in the exemplary embodiment, even in a case where the update processing is performed, a non-updated application program is maintained without destruction until the result of the processing with respect to the test data satisfies the predetermined condition.

Furthermore, in the exemplary embodiment, in a case where the result of the processing with respect to the test data does not satisfy the predetermined condition, the application program is not updated and the application program, which is maintained, is used again.

The transmission/reception unit 16 transmits information to the four servers (the vulnerability information storage server 200, the first program storage server 300, the second program storage server 400, and the test data storage server 500) and the second to fourth image forming apparatuses 170 to 190. In addition, the transmission/reception unit 16 also functions as an information acquisition section, and receives pieces of information transmitted from the four servers and the second to fourth image forming apparatuses 170 to 190.

The stop processing unit 17 as an example of a stop section stops the processing performed by the application program (the application program having the vulnerability) which is specified by the specification processing unit 12.

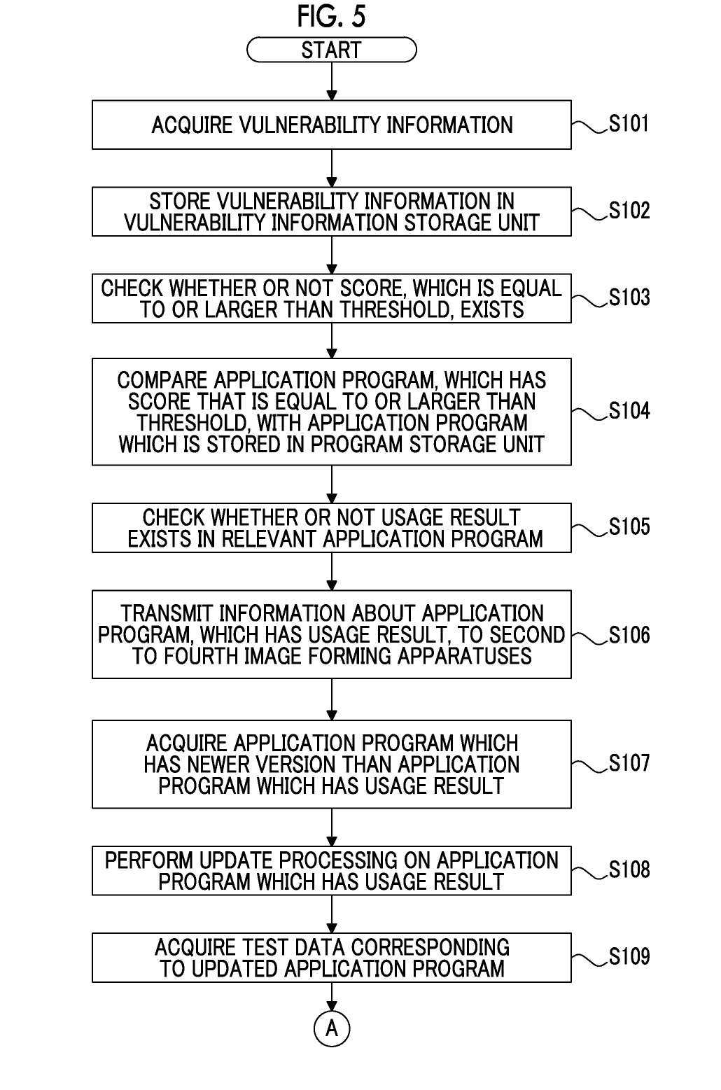

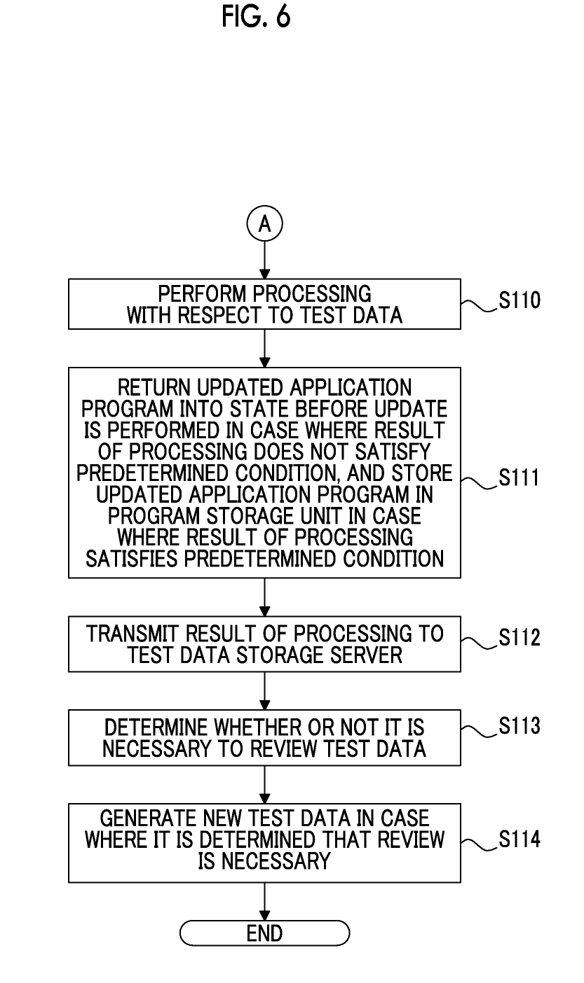

FIGS. 5 and 6 are flowcharts illustrating flows of a series of processes which are performed by the information processing system 1.

In the processing according to the exemplary embodiment, first, the transmission/reception unit 16 of the first image forming apparatus 100 accesses the vulnerability information storage server 200 at each predetermined timing, and acquires the vulnerability information (step 101).

More specifically, the transmission/reception unit 16 accesses the vulnerability information storage server 200, for example, once a day, and acquires the information about the application program having the vulnerability.

Furthermore, in a case where the transmission/reception unit 16 receives the information about the application program having the vulnerability, the information is output to the information storage unit 11 and is stored in the vulnerability information storage unit 11C inside the information storage unit 11 (step 102).

Therefore, in the exemplary embodiment, the identification information used to identify each piece of vulnerability information, the score indicative of the risk degree of the vulnerability, the name of the application program having the vulnerability, and the target version of the application program having the vulnerability are stored in the vulnerability information storage unit 11C, as illustrated in FIG. 4B.

Subsequently, in the exemplary embodiment, the specification processing unit 12 specifies the application program, which corresponds to the application program having the vulnerability, and has the usage result and the higher risk degree of the vulnerability than the predetermined risk degree, among the plural application programs which are stored in the program storage unit 11A.

Specifically, first, the specification processing unit 12 refers to the information stored in the vulnerability information storage unit 11C, and checks whether or not a score which is equal to or larger than a predetermined threshold value exists (step 103).

In other words, the specification processing unit 12 refers to the information stored in the vulnerability information storage unit 11C, and checks whether or not an application program, which has a score to be updated, exists.

In the example according to the exemplary embodiment, the score of the application program A is the score to be updated, as illustrated using symbol 4B of FIG. 4B, and thus it is determined that the application program, which has the score to be updated, exists.

More specifically, a score of 9.0 of the application program A indicated by symbol 4B is equal to or larger than the reference score (=8.0) (refer to FIG. 4C) stored in the setting information storage unit 11D. In this case, it is determined that the application program, which has the score to be updated, exists.

Furthermore, in a case where it is determined that the score, which is equal to or larger than the predetermined threshold value, exists (in a case where it is determined that the application program, which has the score to be updated, exists), the specification processing unit 12 checks whether or not the application program, which has the score that is equal to or larger than the predetermined threshold value, is identical to any one of the application programs stored in the program storage unit 11A (step 104).

More specifically, the specification processing unit 12 checks whether or not an application program, which corresponds to the application program having the score that is equal to or larger than the predetermined threshold value (hereinafter, referred to as a “score-exceeding application program”) and which has the same version as that of the score-exceeding application program, exists among the plural application programs stored in the program storage unit 11A.

Furthermore, in a case where the application program, which has the same version as that of the score-exceeding application program (hereinafter, referred to as a “relevant application program”), exists among the plural application programs in the program storage unit 11A, the specification processing unit 12 specifies the relevant application program.

Subsequently, the specification processing unit 12 checks whether or not the usage result exists in the relevant application program (step 105).

In the example according to the exemplary embodiment, the application program A indicated by symbol 4A of FIG. 4A is the relevant application program, and it is checked whether or not the usage result exists in the application program A which is the relevant application program.

In the check processing in step 105, the specification processing unit 12 checks whether or not the usage result exists in the relevant application program based on log information (information indicative of a management result of a program) which is stored in the first image forming apparatus 100, or the like.

Furthermore, in a case where the usage result exists, the specification processing unit 12 specifies the relevant application program as a usage result existing application program.

Furthermore, in the exemplary embodiment, in a case where the usage result existing application program is an application program which is necessary to be updated with urgency, the stop processing unit 17 stops a function of a device which uses the usage result existing application program, and, furthermore, the transmission/reception unit 16 transmits information about the usage result existing application program to the second to fourth image forming apparatuses 170 to 190 (step 106).

More specifically, in the exemplary embodiment, in a case where a value of a score in the vulnerability information storage unit 11C (refer to FIG. 4B) is equal to or larger than the urgent reference score which is necessary to be updated with urgency (refer to FIG. 4C), the processing performed by the usage result existing application program is stopped.

In the example according to the exemplary embodiment, the value of the score in the vulnerability information storage unit 11C (refer to symbol 4B of FIG. 4B) is 9.0, and the value is equal to or larger than the urgent reference score (=9.0) (refer to FIG. 4C) stored in the setting information storage unit 11D. Therefore, in the example according to the exemplary embodiment, the processing performed by the application program (application program A) which has the usage result is stopped.

Furthermore, in this case (in a case where the processing performed by the usage result existing application program is stopped), the information about the usage result existing application program (information indicative of the name or the version of the usage result existing application program) is transmitted to the second to fourth image forming apparatuses 170 to 190.

Meanwhile, as described above, in the exemplary embodiment, in a case where the value of the score in the vulnerability information storage unit 11C is equal to or larger than the urgent reference score, the processing performed by the usage result existing application program is stopped. However, in a case where the value of the score in the vulnerability information storage unit 11C is equal to or larger than a normal reference score (in a case where the value is not equal to or larger than the urgent reference score but is equal to or larger than the normal reference score), the processing performed by the usage result existing application program may be stopped.

In addition, in the above, a case is described where the information is transmitted to each of the second to fourth image forming apparatuses 170 to 190 in a case where the value of the score in the vulnerability information storage unit 11C is equal to or larger than the urgent reference score. However, the information relevant to the vulnerability may be transmitted from the first image forming apparatus 100 to the second to fourth image forming apparatuses 170 to 190, which each is another image forming apparatuses, regardless of a size of the value of the score in the vulnerability information storage unit 11C.

More specifically, in a case where the first image forming apparatus 100 acquires the information about the application program having the vulnerability, the information may be transmitted (transferred) to each of the second to fourth image forming apparatuses 170 to 190 regardless of the risk degree of the vulnerability (the value of the score).

In addition, in this case, not only the information used to specify the application program having the vulnerability but also information, such as the score which is the information indicative of the risk degree of the vulnerability or the target version, may be transmitted.

Here, in a case where the vulnerability information is supplied to the second to fourth image forming apparatuses 170 to 190, a case is considered where each of the second to fourth image forming apparatuses 170 to 190 directly accesses the vulnerability information storage server 200 and acquires the vulnerability information. However, in this case, each of the first to fourth image forming apparatuses 100 to 190 directly accesses the vulnerability information storage server 200, and thus the loads of the server and the network become large.

In contrast, in a case where a configuration, in which the first image forming apparatus 100 accesses the vulnerability information storage server 200 and the information is transferred from the first image forming apparatus 100 to the second to fourth image forming apparatuses 170 to 190, is made, the loads of the server and the network become small.

Processes subsequent to step 107 will be described.

In step 107, the transmission/reception unit 16 accesses (performs a download request) the first program storage server 300 or the second program storage server 400, and acquires an application program which is the same as the usage result existing application program and which has a newer version than the usage result existing application program.

More specifically, in the exemplary embodiment, a case is illustrated where the application program A corresponds to the usage result existing application program. The transmission/reception unit 16 accesses the first program storage server 300, and acquires the application program A which is the same as the application program A and which has the newer version than the application program A stored in the first image forming apparatus 100.

Subsequently, the update processing unit 13 performs the update processing on the usage result existing application program (step 108).

Specifically, the update processing unit 13 performs version-up on the usage result existing application program into an application program of a new version, which is acquired in step 107.

More specifically, in the exemplary embodiment, the update processing unit 13 performs version-up on the application program A, which is stored in the first image forming apparatus 100, into the application program A of the new version.

Hereinafter, in the specification, the application program acquired after performing version-up is referred to as an updated application program.

Here, in a case where the application program having the vulnerability is stored in the first image forming apparatus 100, it is preferable that, for example, the update processing is performed on the application program. However, in a case where the update processing is uniformly performed, there is a risk that a malfunction occurs such that it is not possible to use some of functions of the first image forming apparatus 100.

In contrast, in the exemplary embodiment, as described above, the update processing is performed on the application program which has the usage result and has the higher risk degree of the vulnerability than the predetermined risk degree.

Therefore, the update processing is performed on an application program in which the update processing is necessary (the update processing is not performed on an application program in which necessity of the update processing is low), and thus the update processing decreases in frequency. Furthermore, in this case, a malfunction, in which it is not possible to use some of the functions, hardly occurs.

Subsequently, processes subsequent to step 109 will be described.

In step 109, the transmission/reception unit 16 downloads and acquires the test data, which corresponds to the updated application program, from the test data storage server 500 (step 109).

Subsequently, the processing unit 14 performs a processing with respect to the test data using the updated application program (step 110).

Furthermore, in the exemplary embodiment, in a case where the result of the processing with respect to the test data does not satisfy the predetermined condition, the return processing unit 15 returns the updated application program to a state before the update is performed (step 111).

In contrast, in a case where the result of the processing with respect to the test data satisfies the predetermined condition, the update processing unit 13 stores the updated application program in the program storage unit 11A as a new application program (step 111).

In other words, in the exemplary embodiment, in a case where the result of the processing with respect to the test data does not satisfy the predetermined condition, the updated application program is downgraded to an original version.

In contrast, in a case where the result of the processing with respect to the test data satisfies the predetermined condition, the updated application program is maintained without downgrading.

Here, in a case where the update processing is performed on the application program, there is a risk that, for example, a specific functional unit of the first image forming apparatus 100 does not operate due to the update process.

As in the exemplary embodiment, in a case where checking is performed using the test data and the update is confirmed only in a case where a result of the checking satisfies the predetermined condition, a malfunction hardly occurs in which the specific functional unit of the first image forming apparatus 100 does not operate.

Meanwhile, here, a case is described where the processing with respect to the test data is performed only once. However, the processing with respect to the test data may be performed plural times.

Specifically, for example, the processing with respect to the test data may be performed again after changing the test data to be used according to the result of the processing with respect to the test data.

More specifically, in this case, first, a first processing with respect to the test data is performed, and a result of the processing is acquired. Furthermore, the transmission/reception unit 16 transmits the result of the processing to the test data storage server 500 (step 112).

Furthermore, the test data storage server 500 determines whether or not it is necessary to review the test data based on the result of the processing (step 113). Furthermore, in a case where it is determined that it is necessary to review the test data, new test data is generated (step 114), and the new test data is transmitted to the first image forming apparatus 100.

Furthermore, in the first image forming apparatus 100, the processing unit 14 performs the processing with respect to the new test data using the updated application program. Therefore, in the process, the processing with respect to the test data is performed plural times. In addition, in the process, different test data is used whenever the processing with respect to the test data is performed.

Here, as described above, in a case where the plural test data is used, it is possible to more accurately check whether or not the processing performed by the updated application is the processing which satisfies the predetermined condition, compared to a case where only one test data is used.

Meanwhile, in the above, in a case where the update processing is performed on the application program having the vulnerability, the update processing is performed on the application program which has the usage result and has the higher risk degree of the vulnerability than the predetermined risk degree. However, in a case where only either one condition is satisfied, the update processing may be performed.

Specifically, in cases where the usage result exists in the update processing performed on the application program having the vulnerability, the update processing may be performed even in a case where the risk degree of the vulnerability is lower than the predetermined risk degree.

In addition, in a case where the risk degree of the vulnerability is higher than the predetermined risk degree in the update processing performed on the application program having the vulnerability, the update processing may be performed even though the usage result does not exist.

In addition, in a case where the vulnerability risk degree is higher than the predetermined risk degree, such as a case of the vulnerability which is urgent, even though the usage result does not exist, the update processing may be performed on the application program.

Specifically, in a case where it is determined whether or not to perform the update processing based on only the usage result in the update processing performed on the application program having the vulnerability, the update processing is not performed in a case where the usage result does not exist. However, in a case where the risk degree of the vulnerability is higher than the predetermined risk degree even through the usage result does not exist, the update processing may be performed on the application program.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
an information storage unit that stores a plurality of application programs;
an information acquisition section that acquires information about an application program having vulnerability;
a specification section that specifies an application program, which corresponds to the application program having the vulnerability and has a usage result, among the application programs stored in the information storage unit; and
an update section that updates the application program specified by the specification section.

2. The image processing apparatus according to claim 1,
wherein the specification section specifies the application program which corresponds to the application program having the vulnerability, and has the usage result and a higher risk degree of the vulnerability than a predetermined risk degree, and
wherein the update section performs an update processing on the application program which corresponds to the application program having the vulnerability, and has the usage result and the higher risk degree of the vulnerability than the predetermined risk degree.

3. The image processing apparatus according to claim 1,
wherein the update section does not perform an update processing on an application program which corresponds to the application program having the vulnerability and does not have the usage result.

4. The image processing apparatus according to claim 3,
wherein the update section performs the update processing on the application program in a case where a risk degree of the vulnerability of the application program, which does not have the usage result, is higher than a predetermined risk degree.

5. The image processing apparatus according to claim 1, further comprising:
a processing section that performs a processing with respect to test data using an updated application program which is an application program updated by the update section.

6. The image processing apparatus according to claim 5, further comprising:
a return section that returns the updated application program to a state before the update is performed in a case where a result of the processing with respect to the test data does not satisfy a predetermined condition.

7. The image processing apparatus according to claim 5,
wherein the processing section performs the processing with respect to the test data a plurality of times, and uses different test data in a case where each processing is performed.

8. The image processing apparatus according to claim 1, further comprising:
a transmission section that transmits the information, which is acquired by the information acquisition section, about the application program having the vulnerability to another image processing apparatus.

9. The image processing apparatus according to claim 8,
wherein the transmission section further transmits information, which indicates a risk degree of the vulnerability of the application program having the vulnerability, to the other image processing apparatus.

10. An image processing apparatus comprising:
an information storage unit that stores a plurality of application programs;
an information acquisition section that acquires information about an application program having vulnerability;
a specification section that specifies an application program, which corresponds to the application program having the vulnerability and has a higher risk degree of the vulnerability than a predetermined risk degree, among the application programs stored in the information storage unit; and
an update section that updates the application program specified by the specification section.

11. The image processing apparatus according to claim 10, further comprising:
a stop section that stops a processing performed by the application program specified by the specification section.

12. The image processing apparatus according to claim 11, further comprising:
a transmission section that transmits information about the application program, for which the processing is stopped by the stop section, to another image processing apparatus.

13. The image processing apparatus according to claim 10, further comprising:
a transmission section that transmits information about the application program updated by the update section to another image processing apparatus.

14. A non-transitory computer readable medium storing a program causing a computer to realize functions comprising:
an information acquisition function of acquiring information about an application program having vulnerability;
a specification function of specifying an application program, which corresponds to the application program having the vulnerability and has a higher risk degree of the vulnerability than a predetermined risk degree, among a plurality of application programs stored in an information storage unit; and
an update function of updating the application program specified by the specification function.
